(19) United States
(12) Patent Application Publication
(10) Pub. No.: US 2025/0189698 A1
(43) Pub. Date: Jun. 12, 2025

(54) MULTILAYER FILM, OPTICAL MEMBER INCLUDING MULTILAYER FILM, AND METHOD FOR PRODUCING MULTILAYER FILM

(71) Applicant: Canon Optron, Inc., Ibaraki (JP)

(72) Inventor: Tetsuya MURATA, Ibaraki (JP)

(21) Appl. No.: 19/055,873

(22) Filed: Feb. 18, 2025

Related U.S. Application Data
(63) Continuation of application No. PCT/JP2022/046346, filed on Dec. 16, 2022.

(30) Foreign Application Priority Data
Sep. 9, 2022 (JP) 2022-144038

(51) Int. Cl. G02B 1/18; G02B 1/116

(52) U.S. Cl. CPC G02B 1/18; G02B 1/116

(57) ABSTRACT

A multilayer film, which sufficiently exhibits a self-cleaning function through a photocatalytic reaction on a surface, and can maintain hydrophilicity in the dark for a long period of time, even when the thickness of a low-refractive-index layer on the surface is set to a specific thickness or more in order to reduce the reflectance of light; an optical member including the multilayer film; and a method of producing the multilayer film. Specifically, a multilayer film to be formed on glass or a resin, the multilayer film including a layer containing specific cerium oxide and a layer containing specific silicon oxide or a layer containing specific magnesium fluoride formed on the layer containing specific cerium oxide directly or through intermediation of another layer; an optical member including the multilayer film; and a method of producing the multilayer film.

### CROSS-REFERENCE TO RELATED APPLICATIONS

This application is a continuation application of International Application No. PCT/JP2022/046346, filed Dec. 16, 2022, which claims the benefit of Japanese Patent Application No. 2022-144038, filed Sep. 9, 2022, both of which are hereby incorporated by reference herein in their entirety.

### BACKGROUND OF THE INVENTION

### Field of the Invention

The present disclosure relates to a multilayer film excellent in self-cleaning property and hydrophilicity, an optical member including the multilayer film, and a method of producing the multilayer film.

### Description of the Related Art

An optical member, such as an optical lens, a mirror, or an optical filter, has a film formed of an inorganic material in order to increase or decrease the transmittance and reflectance of light. The film formed of an inorganic material generally has high surface free energy, and hence has high hydrophilicity immediately after film formation. However, through a self-reaction or the adhesion of dirt derived from a human or an environment, the surface free energy is decreased in a relatively short period of time, resulting in a decrease in hydrophilicity.

For example, when the adhesion of water droplets occurs under a state in which the hydrophilicity of the surface of an optical product to be used in an automobile, an optical product to be used outdoors, such as a security camera or an eyeglass lens, or a protective cover therefor is decreased, visibility may deteriorate, and hence there is a fear in that the functions of the above-mentioned optical products and protective covers cannot be sufficiently exhibited.

As means for solving the above-mentioned problem, a hydrophilic film in which a silicon dioxide thin film is formed on a crystalline titanium dioxide thin film is used (Japanese Patent Application Laid-Open No. 09-057912, Japanese Patent Application Laid-Open No. 2000-053449, and Journal of the Ceramic Society of Japan 110 [5] 450-454 (2002)). When the surface of crystalline titanium dioxide is irradiated with near-ultraviolet light, active oxygen is generated through a photocatalytic function, and the generated active oxygen decomposes an organic substance on the surface of the hydrophilic film. As a result, the hydrophilicity of the hydrophilic film is restored, and dirt is washed away by rainfall. Thus, the hydrophilic film is self-cleaned. In addition, it has been known that, when silicon dioxide is arranged on titanium dioxide, the resultant thin film is not hydrophobized in a short period of time unlike the thin film formed of only titanium dioxide even when light irradiation is stopped, and the hydrophilicity persists for from about 1 week to about 2 weeks even in the dark.

However, when the thickness of the silicon dioxide thin film formed on the crystalline titanium dioxide thin film is less than 50 nm, there is a problem in that the reflectance is increased and the transmittance is decreased because titanium dioxide has a large refractive index. Thus, there is a problem in that, although this hydrophilic film may be applied to an in-vehicle door mirror in which no problem occurs even when the reflectance is increased, the hydrophilic film is not suitable for an optical member such as a lens including an antireflection film.

In addition, when the thickness of the silicon dioxide thin film on the surface formed on the crystalline titanium dioxide thin film is 50 nm or more, there is a problem in that the self-cleaning function through a photocatalytic reaction is not sufficiently exhibited. In addition, there is a problem in that, although the hydrophilicity-maintaining performance in the dark is improved as compared to the case of only the crystalline titanium dioxide, the hydrophilicity-maintaining performance is not sufficient.

In addition, when the crystalline titanium dioxide layer is used as a photocatalyst, there is a problem in that, in order to crystallize a thin film formed of titanium dioxide, the thin film and a base material on which the thin film is arranged may be required to be heated to high temperature, with the result that a base material formed of a resin having low heat resistance cannot be used. The film formation of titanium dioxide by some wet processes does not require heating at high temperature. However, when a wet process is used, there are such inherent problems as described below: it is difficult to perform fine thickness control in units of 1 nm, formation of a thin film having a uniform thickness, and film formation onto a base material except a base material having a simple shape, such as a flat plate; and the storage period of a coating liquid is short.

Considering the application to an optical member, even when the thickness of the low-refractive-index layer on the surface of the optical member is set to be large so that the low-refractive-index layer can be designed as an antireflection film, there has been a demand for a multilayer film that sufficiently exhibits a self-cleaning function through a photocatalytic reaction. In addition, there has been a demand for a multilayer film that maintains hydrophilicity in the dark for a longer period of time.

### SUMMARY OF INVENTION

The present disclosure has been made in view of the above-mentioned problems, and provides a multilayer film, which sufficiently exhibits a self-cleaning function through a photocatalytic reaction on a surface, and can maintain hydrophilicity in the dark for a long period of time, even when the thickness of a low-refractive-index layer on the surface is set to a specific thickness or more in order to reduce the reflectance of light, an optical member including the multilayer film, and a method of producing the multilayer film.

According to the present disclosure, there is provided a multilayer film including: a layer containing cerium oxide; and a layer containing silicon oxide or a layer containing magnesium fluoride formed on the layer containing cerium oxide directly or through intermediation of another layer, wherein the layer containing cerium oxide contains cerium oxide having a cubic polycrystalline structure, wherein the layer containing cerium oxide has a thickness of 70 nm or more and 300 nm or less, wherein the layer containing silicon oxide and the layer containing magnesium fluoride each have a thickness of 50 nm or more and 240 nm or less, and wherein the layer containing silicon oxide and the layer containing magnesium fluoride each have a refractive index of 1.65 or less at a wavelength of 500 nm.

In addition, in the multilayer film of the present disclosure, the multilayer film further includes a layer containing silicon dioxide formed on the layer containing silicon oxide or the layer containing magnesium fluoride directly or through intermediation of another layer. The layer containing silicon dioxide has a thickness of 30 nm or less.

In addition, in the multilayer film of the present disclosure, the multilayer film further includes a layer formed of a first metal oxide between the layer containing cerium oxide and the layer containing silicon oxide or the layer containing magnesium fluoride. The layer formed of a first metal oxide contains a metal oxide having a polycrystalline structure. The layer formed of a first metal oxide has a thickness of 0.5 nm or more and 15 nm or less.

In addition, in the multilayer film of the present disclosure, the multilayer film further includes a layer formed of a second metal oxide between the layer containing silicon oxide or the layer containing magnesium fluoride and the layer containing silicon dioxide. The layer formed of a second metal oxide contains a metal oxide having a polycrystalline structure. The layer formed of a second metal oxide has a thickness of 0.5 nm or more and 7 nm or less.

In addition, according to the present disclosure, there is provided an optical member including the above-mentioned multilayer film of the present disclosure.

In addition, according to the present disclosure, there is provided a method of producing a multilayer film, the method including: forming a layer containing cerium oxide on a base material directly or through intermediation of another layer by a vacuum vapor deposition method; and forming a layer containing silicon oxide or a layer containing magnesium fluoride on the layer containing cerium oxide directly or through intermediation of another layer by the vacuum vapor deposition method, wherein the layer containing cerium oxide contains cerium oxide having a cubic polycrystalline structure, wherein the layer containing cerium oxide has a thickness of 70 nm or more and 300 nm or less, wherein the layer containing silicon oxide and the layer containing magnesium fluoride each have a thickness of 50 nm or more and 240 nm or less, and wherein the layer containing silicon oxide and the layer containing magnesium fluoride each have a refractive index of 1.65 or less at a wavelength of 500 nm.

According to one aspect of the present disclosure, the multilayer film, which sufficiently exhibits a self-cleaning function through a photocatalytic reaction on a surface, and can maintain hydrophilicity even in the dark for a long period of time, even when the thickness of the low-refractive-index layer on the surface is set to a specific thickness or more in order to reduce the reflectance of light, the optical member including the multilayer film, and the method of producing the multilayer film can be obtained.

### BRIEF DESCRIPTION OF DRAWINGS

FIG. 1 is a schematic sectional view for illustrating the configuration of a multilayer film according to a first embodiment of the present disclosure.

FIG. 2 is a schematic sectional view for illustrating the configuration of a multilayer film according to a second embodiment of the present disclosure.

FIG. 3 is a schematic sectional view for illustrating the configuration of a multilayer film according to a third embodiment of the present disclosure.

FIG. 4 is a schematic sectional view for illustrating the configuration of a multilayer film according to a fourth embodiment of the present disclosure.

FIG. 5 is a schematic sectional view for illustrating the configuration of a multilayer film according to a fifth embodiment of the present disclosure.

FIG. 6 is a schematic sectional view for illustrating the configuration of a multilayer film according to a sixth embodiment of the present disclosure.

FIG. 7 is a schematic view for illustrating an optical member according to one embodiment of the present disclosure.

FIG. 8 is a schematic view for illustrating an optical member according to one embodiment of the present disclosure.

### DESCRIPTION OF EMBODIMENTS

Embodiments of a multilayer film, an optical member including the multilayer film, and a method of forming the multilayer film according to the present disclosure are described below by way of exemplary embodiments.

In addition, the present disclosure is not limited to the following embodiments.

In addition, in the present disclosure, the description [XX or more and YY or less] or [XX to YY] representing a numerical range means a numerical range including a lower limit and an upper limit that are end points unless otherwise stated. Further, when the numerical ranges are described in stages, the upper limit and lower limit of each numerical range may be freely combined.

In the present disclosure, the term [multilayer film] refers to a configuration including two or more layers formed on the surface of a base material. The multilayer film according to the present disclosure may be arranged on the base material directly or through intermediation of another layer. The layers for forming the multilayer film may be hereinafter also referred to as “films”.

In the present disclosure, the term [base material] refers to a solid material as an article.

In the present disclosure, the term [optical member] refers to an optical member including the above-mentioned multilayer film. Examples of the optical member include an optical filter, an optical lens, a daylighting lens, an optical film, an optical prism, an eyeglass lens, a photographic lens, a surveillance camera cover, an in-vehicle camera cover, an in-vehicle sensor cover, a vehicle door mirror, a glass sheet, a condenser lens, a display cover glass, a touch panel, and various kinds of films.

Prior to the specific description of the multilayer film according to the present disclosure, for the purpose of understanding the present disclosure, the estimation of a mechanism by which the effects thereof are exhibited is described below. However, the following description is merely a hypothesis, and the present disclosure is not limited by the following hypothesis in any way.

The inventors have found that, when a layer containing cerium oxide having a cubic polycrystalline structure is arranged on a base material directly or through intermediation of another layer, and further, a layer containing magnesium fluoride or silicon oxide having a specific thickness is arranged on the layer containing cerium oxide directly or through intermediation of another layer, a hydrophilicity recovery function through a self-cleaning property with a photocatalyst is exhibited. Regarding the above-mentioned mechanism, the following contents are conceived.

When a photocatalyst film that responds to near-ultraviolet light is irradiated with near-ultraviolet light, holes and electrons are generated by photoexcitation. When the generated holes and electrons can reach the surface of the film, a chemical reaction occurs, and hence the hydrophilicity recovery function through a self-cleaning property is exhibited. However, when a low-refractive-index layer having a specific thickness of more than 50 nm is formed on crystalline titanium dioxide, the holes and the electrons generated by photoexcitation are blocked by the thickness, and hence the holes and the electrons cannot reach the surface of the multilayer film. Thus, the holes and the electrons are recombined to be deactivated, and hence the hydrophilicity recovery function through a self-cleaning property is not exhibited. Meanwhile, when a low-refractive-index layer having a thickness of more than 50 nm is formed on the layer containing cerium oxide of the present disclosure, as compared to the case in which the low-refractive-index layer is formed on crystalline titanium dioxide, the ratio of the holes and the electrons that reach the surface of the multilayer film is increased to cause a chemical reaction, and thus the hydrophilicity recovery function through a self-cleaning property is exhibited. At the interface between the layer containing cerium oxide of the present disclosure and the upper layer in contact with the layer containing cerium oxide, there is a region in which the respective layers are interdiffused, such as a compound or a mixture. Trivalent cerium and tetravalent cerium are easily mixed in this region, and hence the electrons generated by photoexcitation are easily held. Thus, there is a possibility that the holes and the electrons are not easily recombined. In addition, cerium oxide in the layer containing cerium oxide has a cubic polycrystalline structure, and hence conductivity is high and a large number of interfaces are present. Thus, there is a possibility that the holes and the electrons are easily moved and are not easily recombined.

In addition, the inventors have found that, when a layer containing cerium oxide having a cubic polycrystalline structure is arranged on a base material directly or through intermediation of another layer, and further, a layer containing magnesium fluoride or silicon oxide is arranged on the upper layer side, a hydrophilicity-maintaining ability in the dark is significantly improved. Regarding the above-mentioned mechanism, the following contents are conceived.

When a layer containing cerium oxide having a cubic polycrystalline structure is exposed to ultraviolet light or a light beam having energy higher than that of the ultraviolet light, electrical energy, chemical energy, and the like are stored in cerium oxide and at the interface. It is conceived that, when the layer containing cerium oxide of the present disclosure supplies the stored energy to the surface side of the multilayer film, the surface energy of the multilayer film is maintained in a high state, and the hydrophilicity in the dark is improved. In particular, in the layer containing cerium oxide of the present disclosure formed by vacuum vapor deposition, trivalent cerium and tetravalent cerium are easily mixed, and hence there is a possibility that the layer is brought into a state in which energy is easily stored.

### First Embodiment

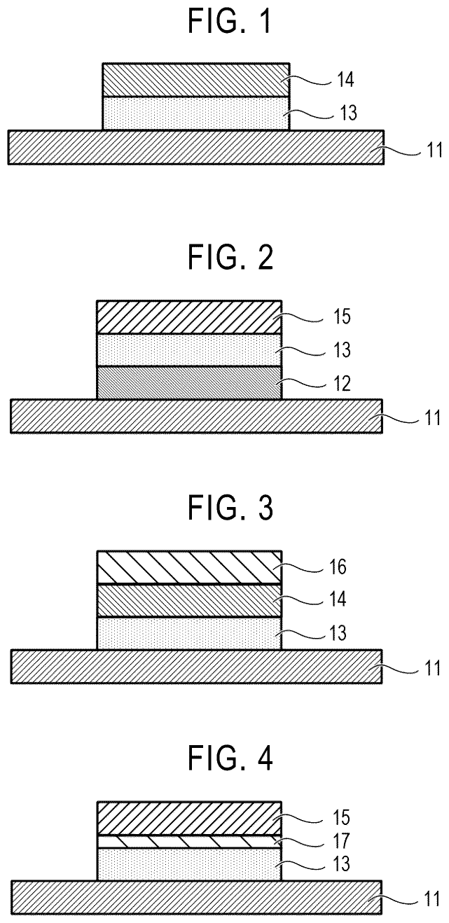

FIG. 1 is a schematic sectional view for illustrating a multilayer film according to a first embodiment of the present disclosure arranged on a base material. In this embodiment, there is illustrated a configuration example in which a layer 13 containing cerium oxide of the present disclosure is formed on a base material 11, and further, a layer 14 containing magnesium fluoride is formed on the layer 13 containing cerium oxide. In each of FIG. 1 to FIG. 6, the configuration of the multilayer film in the present disclosure is schematically illustrated. Thus, the area, thickness, and the like of each of the layers are not illustrated in accurate proportions.

The base material 11 is described.

It is only required that the base material 11 enable another layer 12 or the layer 13 containing cerium oxide of the present disclosure to be laminated thereon, and glass, a ceramic, a resin, a metal, or the like may be used. The shape of the base material is not limited, and the base material may have, for example, a flat surface shape, a curved surface shape, a concave surface shape, a convex surface shape, or a film shape. In addition, the base material 11 may include a hard coat layer or a barrier layer. In addition, the size and thickness of the base material 11 are not particularly limited, and may be appropriately set in accordance with applications and the like.

The layer 13 containing cerium oxide according to the present disclosure is described. The layer 13 containing cerium oxide of the present disclosure is a layer containing cerium oxide (CeOₓ) having a cubic polycrystalline structure. In a layer formed of cerium oxide having a single crystalline structure, cracks are liable to occur in the film. When the layer is formed of cerium oxide having an amorphous structure, the self-cleaning function with a photocatalyst and the hydrophilicity-maintaining ability in the dark are significantly decreased.

The term [polycrystalline structure] as defined in the present disclosure means that a peak unique to cerium oxide appears in X-ray diffraction (XRD) measurement of a film after film formation.

The layer 13 containing cerium oxide of the present disclosure has a thickness of 70 nm or more and 300 nm or less. When the thickness of the layer 13 containing cerium oxide is less than 70 nm, the self-cleaning function with a photocatalyst and the hydrophilicity-maintaining ability in the dark are significantly decreased. In addition, the thickness of the layer 13 containing cerium oxide is more than 300 nm, cracks are liable to occur, and heterogeneity and surface roughness may become too large, which may adversely influence optical characteristics.

The composition of cerium oxide in the layer 13 containing cerium oxide of the present disclosure is CeOₓ, and the “x” preferably represents 1.5 or more and 2.0 or less. When the value of the “x” in the composition CeOₓ of cerium oxide falls within the above-mentioned range, a more transparent film can be obtained in a wavelength range of from visible light to near-infrared light.

The content ratio of cerium oxide in the layer 13 containing cerium oxide of the present disclosure is preferably 85 mass % or more with respect to the entirety of the layer 13 containing cerium oxide. When the content ratio of cerium oxide is 85 mass % or more, the hydrophilicity-maintaining ability in the dark is further enhanced.

The layer 13 containing cerium oxide of the present disclosure may be arranged directly on the base material 11 or may be arranged thereon through intermediation of the another layer 12 described later.

The layer 14 containing magnesium fluoride according to the present disclosure is described. The thickness of the layer 14 containing magnesium fluoride is 50 nm or more and 240 nm or less. When the thickness of the layer 14 containing magnesium fluoride is less than 50 nm, the reflectance of the multilayer film may become too high. Meanwhile, when the thickness of the layer 14 containing magnesium fluoride is more than 240 nm, the self-cleaning function with a photocatalyst may not be exhibited on the surface of the multilayer film. In addition, the refractive index of the layer 14 containing magnesium fluoride is 1.65 or less at a wavelength of 500 nm. When the refractive index of the layer 14 containing magnesium fluoride is more than 1.65, the reflectance of the multilayer film may become too high.

The content ratio of magnesium fluoride in the total amount of substances for forming the layer 14 containing magnesium fluoride is preferably 65 mass % or more. When the content ratio falls within the above-mentioned range, the hydrophilicity-maintaining ability in the dark is further enhanced.

### Second Embodiment

FIG. 2 is a schematic sectional view for illustrating a multilayer film according to a second embodiment of the present disclosure. In this embodiment, the multilayer film according to the present disclosure is arranged on the another layer 12 arranged on the base material 11. That is, in the second embodiment, there is illustrated a configuration example in which the another layer 12 is formed on the base material 11, further, the layer 13 containing cerium oxide of the present disclosure is formed on the another layer 12, and in addition, a layer 15 containing silicon oxide is formed on the layer 13 containing cerium oxide.

The base material 11 and the layer 13 containing cerium oxide of the present disclosure are as described in the above-mentioned first embodiment.

In this embodiment, the layer 14 containing magnesium fluoride described in the first embodiment may be arranged instead of the entirety or part of the layer 15 containing silicon oxide. In addition, the layer 13 containing cerium oxide of the present disclosure may be arranged directly on the base material 11 without intermediation of the another layer 12.

A layer containing a metal, a fluoride, an oxide, a carbide, or a nitride may be arranged as the another layer 12. Specific examples of the layer that may be used as the another layer 12 include: a metal layer containing an element, such as aluminum (Al), chromium (Cr), gold (Au), silver (Ag), copper (Cu), silicon (Si), germanium (Ge), titanium (Ti), or nickel (Ni); a layer containing a fluoride, such as magnesium fluoride (MgF₂) or calcium fluoride (CaF₂); a layer containing an oxide, such as silicon oxide (SiOₓ), aluminum oxide (Al₂Oₓ), yttrium oxide (Y₂Oₓ), zirconium oxide (ZrOₓ), hafnium oxide (HfOₓ), zinc oxide (ZnOₓ), tantalum oxide (Ta₂Oₓ), niobium oxide (Nb₂Oₓ), indium oxide (In₂Oₓ), tin oxide (SnOₓ), tungsten oxide (WOₓ), cerium oxide (CeOₓ), titanium oxide (TiOₓ), lanthanum titanate (LaₓTi_{y}O_{z}), aluminum titanate (LaₓAl_{y}O_{z}), or alumina-doped silicon dioxide (SiO₂+Al₂O₃); a layer containing a nitride such as silicon nitride (Si₃N₄); and a layer containing a carbide such as tungsten carbide (WC). The another layer 12 may be one layer, or a multilayer of two or more layers. When the another layer 12 is a multilayer of two or more layers, the another layer 12 may be formed of a combination of a plurality of kinds of layers among the layers exemplified above. In addition, the another layer 12 may be a layer containing a mixture formed of two or more kinds of the compounds in the layers exemplified above.

A method of forming the another layer 12 is not particularly limited. As the method of forming the another layer 12, for example, a dry film forming method, such as a sputtering method, a vacuum vapor deposition method, or an ion plating method, or a wet film forming method, such as a dipping method, a coating method, a spraying method, a spin coating method, a bar coating method, a printing method, or a flow coating method, may be applied.

When the composition, refractive index, thickness, number of layers, and the like of the another layer 12 are set in accordance with purposes and functions, a multilayer film having imparted thereto a specific function, such as an antireflection layer, a half mirror layer, a light-absorbing layer, an alkali diffusion-preventing layer, an adhesion layer, an antistatic layer, or a heater layer, can be formed.

The refractive index of the layer 15 containing silicon oxide is 1.65 or less at a wavelength of 500 nm. When the refractive index is more than 1.65, the reflectance of the multilayer film may become too high.

The layer 15 containing silicon oxide is a layer containing silicon oxide (SiOₓ). The content ratio of silicon oxide in the layer 15 containing silicon oxide is preferably 65 mass % or more with respect to the entirety of the layer 15 containing silicon oxide. When the content ratio of silicon oxide in the layer 15 containing silicon oxide falls within the above-mentioned range, the hydrophilicity-maintaining ability in the dark is further enhanced.

In the layer 15 containing silicon oxide, the composition of silicon oxide is SiOₓ, and the “x” represents preferably 1.5 or more and 2.0 or less. When the value of the “x” in the composition SiOₓ of silicon oxide falls within the above-mentioned range, the refractive index of the layer 15 containing silicon oxide can be set to 1.65 or less. In addition, a more transparent film can be obtained in a wavelength range of from visible light to near-infrared light.

The layer 15 containing silicon oxide may contain aluminum oxide in addition to silicon oxide (SiOₓ). In this case, the content ratio of aluminum oxide in the layer 15 containing silicon oxide is preferably 0.1 mass % or more and 10 mass % or less with respect to the entirety of the layer 15 containing silicon oxide. When the layer 15 containing silicon oxide contains 0.1 mass % to 10 mass % of aluminum oxide, the durability of the multilayer film, such as scratch resistance and moisture resistance, can be enhanced while the self-cleaning function with a photocatalyst and hydrophilicity-maintaining ability in the dark of the multilayer film are kept.

The layer 15 containing silicon oxide may contain cerium oxide in addition to silicon oxide (SiOₓ). In this case, the content ratio of cerium oxide in the layer 15 containing silicon oxide is preferably 0.1 mass % or more and 35 mass % or less with respect to the entirety of the layer 15 containing silicon oxide. When the layer 15 containing silicon oxide contains 0.1 mass % to 35 mass % of cerium oxide, the self-cleaning function with a photocatalyst can be enhanced while the hydrophilicity-maintaining ability of the multilayer film is kept.

### Third Embodiment

FIG. 3 is a schematic sectional view for illustrating a multilayer film according to a third embodiment of the present disclosure arranged on the base material. In the third embodiment, there is illustrated a configuration example in which the layer 13 containing cerium oxide of the present disclosure is formed on the base material 11, further, the layer 14 containing magnesium fluoride is formed on the layer 13 containing cerium oxide, and in addition, a layer 16 containing silicon dioxide is formed on the layer 14 containing magnesium fluoride.

The base material 11, the layer 13 containing cerium oxide of the present disclosure, and the layer 14 containing magnesium fluoride are as described in the above-mentioned first and second embodiments. The layer 15 containing silicon oxide described in the second embodiment may be arranged instead of the entirety or part of the layer 14 containing magnesium fluoride. In addition, the layer 13 containing cerium oxide of the present disclosure may be arranged directly on the base material 11, or may be arranged through intermediation of the another layer 12 described in the second embodiment.

The layer 16 containing silicon dioxide according to the present disclosure is described. The multilayer film according to the present disclosure preferably includes the layer 16 containing silicon dioxide having a thickness of 30 nm or less on the upper layer side of the layer 14 containing magnesium fluoride or the layer 15 containing silicon oxide. With this configuration, the hydrophilicity-maintaining ability in the dark can be further enhanced.

The refractive index of the layer 16 containing silicon dioxide is preferably 1.65 or less at a wavelength of 500 nm. When the refractive index of the layer 16 containing silicon dioxide is more than 1.65, the reflectance of the multilayer film may become too high.

### Fourth Embodiment

FIG. 4 is a schematic sectional view for illustrating a multilayer film according to a fourth embodiment of the present disclosure arranged on the base material. In the fourth embodiment, there is illustrated a configuration example in which the layer 13 containing cerium oxide of the present disclosure is formed on the base material 11, further, a layer 17 formed of a first metal oxide of the present disclosure is arranged on the layer 13 containing cerium oxide, and in addition, the layer 15 containing silicon oxide is formed on the layer 17 formed of a first metal oxide.

The base material 11, the layer 13 containing cerium oxide of the present disclosure, and the layer 15 containing silicon oxide are as described in the above-mentioned first to third embodiments. The layer 14 containing magnesium fluoride described in the first embodiment may be arranged instead of the entirety or part of the layer 15 containing silicon oxide. In addition, the layer 13 containing cerium oxide of the present disclosure may be arranged directly on the base material 11, or may be arranged through intermediation of the another layer 12 described in the second embodiment.

The layer 17 formed of a first metal oxide according to the present disclosure is described. The layer 17 formed of a first metal oxide contains a metal oxide having a polycrystalline structure, and the thickness of the layer 17 formed of a first metal oxide is preferably 0.5 nm or more and 15 nm or less. In the multilayer film according to the present disclosure, it is preferred that the layer 17 formed of a first metal oxide of the present disclosure be arranged between the layer 13 containing cerium oxide of the present disclosure and the layer 14 containing magnesium fluoride or the layer 15 containing silicon oxide. When the multilayer film according to the present disclosure has such configuration, the hydrophilicity-maintaining ability in the dark and the self-cleaning function with a photocatalyst are enhanced. The metal oxide in the layer 17 formed of a first metal oxide may be a simple oxide or a complex oxide. In addition, the layer 17 formed of a first metal oxide may contain a plurality of two or more kinds of metal oxides as well as only one kind of metal oxide.

The metal oxide in the layer 17 formed of a first metal oxide of the present disclosure described above is preferably cerium oxide represented by the composition CeOₓ (x=1.5 or more and 2.0 or less) or copper oxide represented by the composition CuOₓ (x=0.5 or more and 1.0 or less). Through use of those oxides, the hydrophilicity-maintaining ability in the dark and the self-cleaning function with a photocatalyst can be further enhanced.

The thickness of the layer 17 formed of a first metal oxide of the present disclosure described above is preferably 0.5 nm or more and 15 nm or less. When the thickness of the layer 17 formed of a first metal oxide falls within the above-mentioned range, the hydrophilicity-maintaining ability in the dark and the self-cleaning function with a photocatalyst can be further enhanced without adverse influence on a light transmittance.

### Fifth Embodiment

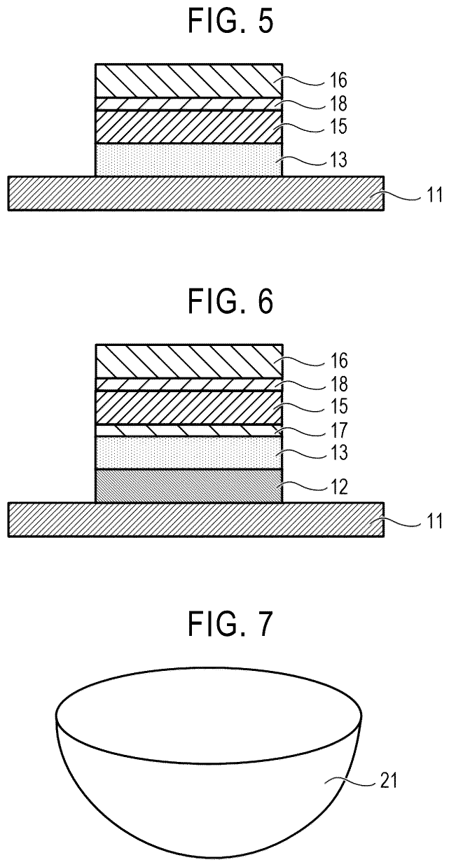

FIG. 5 is a schematic sectional view for illustrating a multilayer film according to a fifth embodiment of the present disclosure arranged on the base material. In the fifth embodiment, there is illustrated a configuration example in which the layer 13 containing cerium oxide of the present disclosure is formed on the base material 11, further, the layer 15 containing silicon oxide is formed on the layer 13 containing cerium oxide, in addition, a layer 18 formed of a second metal oxide of the present disclosure is arranged on the layer 15 containing silicon oxide, and finally, the layer 16 containing silicon dioxide is formed on the layer formed of a second metal oxide.

The base material 11, the layer 13 containing cerium oxide of the present disclosure, and the layer 15 containing silicon oxide are as described in the above-mentioned first to fourth embodiments. The layer 14 containing magnesium fluoride described in the first embodiment may be arranged instead of the entirety or part of the layer 15 containing silicon oxide. In addition, the layer 13 containing cerium oxide of the present disclosure may be arranged directly on the base material 11, or may be arranged through intermediation of the another layer 12 described in the second embodiment.

The layer 18 formed of a second metal oxide having a polycrystalline structure according to the present disclosure is described. The layer 18 formed of a second metal oxide contains a metal oxide having a polycrystalline structure, and the thickness of the layer 18 formed of a second metal oxide is preferably 0.5 nm or more and 7 nm or less. In the multilayer film according to the present disclosure, it is preferred that the layer 18 formed of a second metal oxide be arranged between the layer 15 containing silicon oxide and the layer 16 containing silicon dioxide. When the multilayer film according to the present disclosure has such configuration, the self-cleaning function with a photocatalyst is further enhanced. The metal oxide in the layer 18 formed of a second metal oxide may be a simple oxide or a complex oxide. In addition, the layer 18 formed of a second metal oxide may contain two or more kinds of metal oxides as well as only one kind of metal oxide.

In the fifth embodiment, a layer except the layer 18 formed of a second metal oxide of the present disclosure may be arranged between the layer 15 containing silicon oxide and the layer 16 containing silicon dioxide. One or more layers containing various substances, such as a fluoride and a nitride, may be arranged to the extent that the hydrophilicity-maintaining ability in the dark and the self-cleaning function with a photocatalyst are not adversely influenced.

The metal oxide in the layer 18 formed of a second metal oxide of the present disclosure is preferably cerium oxide of the present disclosure having a cubic polycrystalline structure represented by the composition CeOₓ (x=1.5 or more and 2.0 or less) or copper oxide represented by the composition CuOₓ (x=0.5 or more and 1.0 or less). Through use of those oxides, the self-cleaning function with a photocatalyst can be particularly enhanced.

### Sixth Embodiment

FIG. 6 is a schematic sectional view for illustrating a multilayer film according to a sixth embodiment of the present disclosure arranged on the base material. In the sixth embodiment, there is illustrated a configuration example in which the another layer 12 is formed on the base material 11, and subsequently, the layer 13 containing cerium oxide of the present disclosure, the layer 17 formed of a first metal oxide of the present disclosure, the layer 15 containing silicon oxide, the layer 18 formed of a second metal oxide of the present disclosure, and the layer 16 containing silicon dioxide are formed in the stated order.

The base material 11 and each of the layers are as described in the above-mentioned first to fifth embodiments. The layer 14 containing magnesium fluoride described in the first embodiment may be arranged instead of the entirety or part of the layer 15 containing silicon oxide.

Each layer of the multilayer film of the present disclosure may contain another compound or atom to the extent that the present disclosure is not influenced. That is, in addition to impurities that are inevitably present in the composition of the present disclosure, another compound or atom may be added as required to the extent that the present disclosure is not influenced.

### <<Optical Member>>

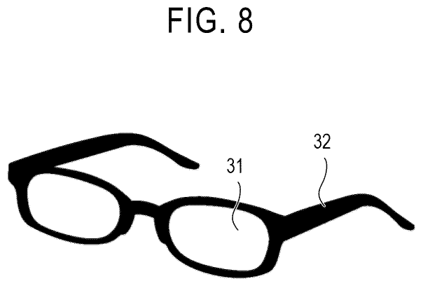

FIG. 7 and FIG. 8 are each a schematic view for illustrating the configuration of an optical member according to one embodiment of the present disclosure. FIG. 7 is an illustration of a lens cover for a surveillance camera in which the multilayer film of the present disclosure is formed on the surface of a dome-shaped resin substrate 21. In addition, FIG. 8 is an illustration of a pair of eyeglasses including: eyeglass lenses 31 that are each the optical member according to one embodiment of the present disclosure; and an eyeglass frame 32. The multilayer film of the present disclosure is formed on each surface of the eyeglass lens 31.

The multilayer film of the present disclosure may be used as an optical thin film, such as an antireflection film, various kinds of optical filter multilayer films, or an optical mirror multilayer film. In addition, the multilayer film of the present disclosure may be used in, for example, optical members, such as an optical filter, an optical lens, a daylighting lens, an optical film, an optical prism, an eyeglass lens, a photographic lens, a surveillance camera cover, an in-vehicle camera cover, an in-vehicle sensor cover, a vehicle door mirror, a glass sheet, a condenser lens, a display cover glass, a touch panel, and various kinds of films, or covers for protecting the optical members. In addition, when the surface of the base material 11 except the surface on which the above-mentioned layers are arranged is coated with a layer having the composition, refractive index, thickness, number of layers, and the like in accordance with purposes and functions, the multilayer film can be formed as an optical member having imparted thereto a specific function, such as a mirror layer, a half mirror layer, a light-absorbing layer, a transparent heater layer, or an antireflection layer.

### <<Method of Producing Multilayer Film>>

In addition, a method of producing a multilayer film of the present disclosure is characterized by forming a multilayer film by a method including at least the following steps (A) and (B):
(A) a step of forming the layer 13 containing cerium oxide on the base material directly or through intermediation of another layer by a vacuum vapor deposition method; and
(B) a step of forming the layer 14 containing magnesium fluoride or the layer 15 containing silicon oxide on the above-mentioned layer 13 containing cerium oxide of the present disclosure by the vacuum vapor deposition method.

The layer 13 containing cerium oxide formed in the step (A) contains cerium oxide having a cubic polycrystalline structure, and the thickness of the layer 13 containing cerium oxide formed in the step (A) is 70 nm or more and 300 nm or less. In addition, the thickness of each of the layer 14 containing magnesium fluoride and the layer 15 containing silicon oxide formed in the step (B) is 50 nm or more and 240 nm or less, and the refractive index of each of the layer 14 containing magnesium fluoride and the layer 15 containing silicon oxide formed in the step (B) is 1.65 or less at a wavelength of 500 nm.

The temperature of the base material when vacuum vapor deposition is performed is preferably a temperature at which cerium oxide is crystallized. Although depending on the heat-resistant temperature of a base material to be used and other film forming conditions, the temperature may be generally selected in a range of 0° C. or more and 500° C. or less.

An evaporation method in vacuum vapor deposition is not limited as long as the evaporation method is a method in which a film forming material is evaporated. For example, as the evaporation method, evaporation means, such as an electron gun, resistance heating, or a laser, may be applied. In addition, ion assisted deposition, plasma assisted deposition, or the like may be used in combination with the evaporation means as required.

The multilayer film of the present disclosure can be suitably produced by the above-mentioned method.

### EXAMPLES

The present disclosure is described in more detail below by way of Examples. The present disclosure is by no means limited to Examples below.

Materials used for producing and evaluating multilayer films in Examples are described below.

### (Base Material)

Flat plates made of materials described below were used as base materials. When the base material temperature at the time of vapor deposition was 350° C., two kinds of base materials of borosilicate glass and synthetic quartz were used. In the case of any other base material temperature, all of the following base materials were used.
Borosilicate glass: thickness of 3 mm
Synthetic quartz: thickness of 3 mm
Polycarbonate resin: thickness of 2 mm
Polymethyl methacrylate resin: thickness of 2 mm

### (Film Forming Material)

Materials described below were used.
Ce: granular, purity of 99.9%
CeO₂: columnar, purity of 99.9%
La₂O₃: columnar, purity of 99.9%
Sm₂O₃: columnar, purity of 99.9%
SiO: granular, purity of 99.9%
SiO₂: granular, purity of 99.9%
Al₂O₃: granular, purity of 99.9%
MgF₂: granular, purity of 99.9%
CaF₂: granular, purity of 99.9%
ZrO₂: columnar, purity of 99.9%
Ti₃O₅: granular, purity of 99.9%
CuO: granular, purity of 99.9%
Cu₂O: granular, purity of 99.9%
O₂: gas, purity of 99.999%

### (Reagents and the Like)

Pure water
Stearic acid: JIS K 8585 special grade, purity of 99.9%
Heptane: JIS K 9701 special grade, purity of 99.9%

### (Production of Multilayer Film)

A film forming method and film forming conditions common to Examples and Comparative Examples in production of a multilayer film are described. A vacuum vapor deposition apparatus (dome diameter: ϕ900 mm, vapor deposition distance: 890 mm) was used as a film forming apparatus. The above-mentioned film forming materials and various kinds of clean base materials were set in the apparatus, and the apparatus was evacuated to a degree of vacuum (7.0×10⁻⁴ Pa) at which film formation was started. The base material temperature at the time of film formation is −10° C. or more and 350° C. or less. After that, a multilayer film of the film forming materials was formed on the set base material by a vacuum vapor deposition method as shown in Table 1 (Table 1-1 to Table 1-4) to provide a test piece. In this case, the material for each layer was deposited from the vapor at a vapor deposition rate of 0.5 nm/sec. A film formed of two components, such as CeO₂+Al₂O₃ or SiO₂+Al₂O₃, was formed by a dual vapor deposition method involving setting two kinds of film forming materials in heating sources at two locations and simultaneously evaporating the film forming materials. In each of Examples 1 to 47 and Comparative Examples 1 to 8, there was no substantial difference between the multilayer films obtained by changing the kind of the base material, and hence only one example is shown in Table 1. In addition, the term “polycrystalline” in Table 1 means a cubic polycrystalline structure.

Individual conditions in each of Examples and Comparative examples in production of a multilayer film are described below.

### Examples 1 to 3

A CeO₂ film was formed on each of various kinds of base materials heated to 350° C. through use of CeO₂ as a film forming material. Subsequently, a MgF₂ film was formed thereon through use of MgF₂ as a film forming material to produce a multilayer film. Other film forming conditions are as described in the section (Production of Multilayer Film).

### Examples 4 to 6

A CeO₂ film was formed on each of various kinds of base materials heated to 350° C. through use of CeO₂ as a film forming material. Subsequently, a SiO₂ film was formed thereon through use of SiO₂ as a film forming material to produce a multilayer film. Other film forming conditions are as described in the section (Production of Multilayer Film).

### Example 7

A CeO_{1.8} film was formed on each of various kinds of base materials heated to 350° C. through use of CeO₂ and Ce as film forming materials. Subsequently, a MgF₂ film was formed thereon through use of MgF₂ as a film forming material to produce a multilayer film. Other film forming conditions are as described in the section (Production of Multilayer Film).

### Example 8

A CeO_{1.8} film was formed on each of various kinds of base materials heated to 350° C. through use of CeO₂ and Ce as film forming materials. Subsequently, a SiO₂ film was formed thereon through use of SiO₂ as a film forming material to produce a multilayer film. Other film forming conditions are as described in the section (Production of Multilayer Film).

### Example 9

A CeO_{1.5} (85%)+La₂O₃ (15%) film was formed on each of various kinds of base materials heated to 350° C. through use of two materials of CeO₂ and La₂O₃ as film forming materials so as to achieve the composition shown in Table 1. Subsequently, a MgF₂ film was formed thereon through use of MgF₂ as a film forming material to produce a multilayer film. Other film forming conditions are as described in the section (Production of Multilayer Film).

### Example 10

A CeO_{1.8}+Al₂O₃ film was formed on each of various kinds of base materials heated to 350° C. through use of two materials of CeO₂ and Al₂O₃ as film forming materials so as to achieve the composition shown in Table 1. Subsequently, a SiO₂ film was formed thereon through use of SiO₂ as a film forming material to produce a multilayer film. Other film forming conditions are as described in the section (Production of Multilayer Film).

### Example 11

A CeO_{1.5}+Sm₂O₃ film was formed on each of various kinds of base materials heated to 350° C. through use of two materials of CeO₂ and Sm₂O₃ as film forming materials so as to achieve the composition shown in Table 1. Subsequently, a SiO₂ film was formed thereon through use of SiO₂ as a film forming material to produce a multilayer film. Other film forming conditions are as described in the section (Production of Multilayer Film).

### Examples 12 to 17

A CeO₂ film was formed on each of various kinds of base materials heated to 350° C. through use of CeO₂ as a film forming material. Subsequently, a SiO₂+Al₂O₃ film was formed thereon through use of SiO₂ and Al₂O₃ as film forming materials so as to achieve the composition shown in Table 1, to thereby produce a multilayer film. Other film forming conditions are as described in the section (Production of Multilayer Film).

### Examples 18 to 23

A CeO₂ film was formed on each of various kinds of base materials heated to 350° C. through use of CeO₂ as a film forming material. Subsequently, a SiO₂+CeO₂ film was formed thereon through use of two materials of SiO₂ and CeO₂ as film forming materials so as to achieve the composition shown in Table 1, to thereby produce a multilayer film. Other film forming conditions are as described in the section (Production of Multilayer Film).

### Examples 24 and 25

A CeO₂ film was formed on each of various kinds of base materials heated to 350° C. through use of CeO₂ as a film forming material. Subsequently, a MgF₂ film was formed thereon through use of MgF₂ as a film forming material. Further, a SiO₂ film was formed thereon through use of SiO₂ to produce a multilayer film. Other film forming conditions are as described in the section (Production of Multilayer Film).

### Examples 26 and 27

A CeO₂ film was formed on each of various kinds of base materials heated to 350° C. through use of CeO₂ as a film forming material. Subsequently, a SiO₂+Al₂O₃ film was formed thereon through use of two materials of SiO₂ and Al₂O₃ as film forming materials so as to achieve the composition shown in Table 1. Further, a SiO₂ film was formed thereon through use of SiO₂ to produce a multilayer film. Other film forming conditions are as described in the section (Production of Multilayer Film).

### Examples 28 to 30

A CeO₂ film was formed on each of various kinds of base materials heated to 350° C. through use of CeO₂ as a film forming material. Subsequently, a SiO₂+CeO₂ film was formed thereon through use of SiO₂ and CeO₂ as film forming materials so as to achieve the composition shown in Table 1. Further, a SiO₂ film was formed thereon through use of SiO₂ to produce a multilayer film. Other film forming conditions are as described in the section (Production of Multilayer Film).

### Examples 31 to 33

A CeO₂ film was formed on each of various kinds of base materials heated to 350° C. through use of CeO₂ as a film forming material. Subsequently, a CuO film was formed thereon through use of CuO as a film forming material. Further, a SiO₂+CeO₂ film was formed thereon through use of SiO₂ and CeO₂ as film forming materials so as to achieve the composition shown in Table 1, to thereby produce a multilayer film. Other film forming conditions are as described in the section (Production of Multilayer Film).

### Example 34

A CeO_{1.5}+La₂O₃ film was formed on each of various kinds of base materials heated to 350° C. through use of two materials of CeO₂ and La₂O₃ as film forming materials so as to achieve the composition shown in Table 1. Subsequently, a CeO₂ film was formed thereon through use of CeO₂ as a film forming material. Further, a SiO₂+CeO₂ film was formed thereon through use of two materials of SiO₂ and CeO₂ as film forming materials so as to achieve the composition shown in Table 1, to thereby produce a multilayer film. Other film forming conditions are as described in the section (Production of Multilayer Film).

### Example 35

A CeO_{1.8}+Al₂O₃ film was formed on each of various kinds of base materials heated to 350° C. through use of two materials of CeO₂ and Al₂O₃ as film forming materials so as to achieve the composition shown in Table 1. Subsequently, a CeO₂ film was formed thereon through use of CeO₂ as a film forming material. Further, a SiO₂+CeO₂ film was formed thereon through use of SiO₂ and CeO₂ as film forming materials so as to achieve the composition shown in Table 1, to thereby produce a multilayer film. Other film forming conditions are as described in the section (Production of Multilayer Film).

### Example 36

A CeO_{1.5}+Sm₂O₃ film was formed on each of various kinds of base materials heated to 350° C. through use of two materials of CeO₂ and Sm₂O₃ as film forming materials so as to achieve the composition shown in Table 1. Subsequently, a CeO₂ film was formed thereon through use of CeO₂ as a film forming material. Further, a SiO₂+CeO₂ film was formed thereon through use of SiO₂ and CeO₂ as film forming materials so as to achieve the composition shown in Table 1, to thereby produce a multilayer film. Other film forming conditions are as described in the section (Production of Multilayer Film).

### Examples 37 to 39

A CeO₂ film was formed on each of various kinds of base materials heated to 350° C. through use of CeO₂ as a film forming material. Subsequently, a SiO₂+CeO₂ film was formed thereon through use of SiO₂ and CeO₂ as film forming materials so as to achieve the composition shown in Table 1. Further, a CuO film was formed thereon through use of CuO. In addition, a SiO₂ film was formed thereon through use of SiO₂ to produce a multilayer film. Other film forming conditions are as described in the section (Production of Multilayer Film).

### Examples 40 to 42

A CeO₂ film was formed on each of various kinds of base materials heated to 350° C. through use of CeO₂ as a film forming material. Subsequently, a SiO₂+CeO₂ film was formed thereon through use of SiO₂ and CeO₂ as film forming materials so as to achieve the composition shown in Table 1. Further, a CeO₂ film was formed thereon through use of CeO₂. In addition, a SiO₂ film was formed thereon through use of SiO₂ to produce a multilayer film. Other film forming conditions are as described in the section (Production of Multilayer Film).

### Example 43

A multilayer film was produced in the same manner as in Example 5 except that the base material heating temperature of 350° C. in Example 5 was changed to no heating (room temperature). The temperature in the vicinity of the base material during film formation was 28° C. on average.

### Example 44

A multilayer film was produced in the same manner as in Example 16 except that the base material heating temperature of 350° C. in Example 16 was changed to no heating (room temperature). The temperature in the vicinity of the base material during film formation was 28° C. on average.

### Example 45

A multilayer film was produced in the same manner as in Example 29 except that the base material heating temperature of 350° C. in Example 29 was changed to no heating (room temperature). The temperature in the vicinity of the base material during film formation was 29° C. on average.

### Example 46

A multilayer film was produced in the same manner as in Example 41 except that the base material heating temperature of 350° C. in Example 41 was changed to no heating (room temperature). The temperature in the vicinity of the base material during film formation was 33° C. on average.

### Example 47

A CeO₂ film was formed on each of various kinds of base materials heated to 350° C. through use of CeO₂ as a film forming material. Subsequently, a CuO film was formed thereon through use of CuO. Further, a SiO_{1.5}+CeO₂ film was formed thereon through use of SiO and CeO₂ as film forming materials at a film forming rate of 2.5 nm/sec so as to achieve the composition shown in Table 1. In addition, a CuO film was formed thereon through use of CuO. Further, a SiO₂ film was formed thereon through use of a SiO₂ melt to produce a multilayer film. Other film forming conditions are as described in the section (Production of Multilayer Film).

### Example 48

A CeO₂ film was formed on each of various kinds of base materials heated to 350° C. through use of CeO₂ as a film forming material. Subsequently, a CuO film was formed thereon through use of CuO. Further, a MgF₂+CaF₂ film was formed thereon through use of a MgF₂ melt and a CaF₂ melt as film forming materials so as to achieve the composition shown in Table 1. Other film forming conditions are as described in the section (Production of Multilayer Film).

### Comparative Example 1

An anatase-type TiO₂ layer was formed instead of the cubic polycrystalline CeO₂ layer in Example 2. In this case, a film was formed through use of Ti₃O₅ as a film forming material while an O₂ gas was introduced so that the degree of vacuum was 1.8×10⁻² Pa with an Auto Pressure Control (APC) device. A multilayer film was produced in the same method as that in Example 2 except for the foregoing.

Here, the APC device was used in order to adjust a gas partial pressure in the vacuum vapor deposition apparatus.

### Comparative Example 2

A film was formed while an O₂ gas was introduced by changing the film forming material to a Ti₃O₅ material in the same manner as in Comparative Example 1 so that an anatase-type TiO₂ layer was obtained instead of the cubic polycrystalline CeO₂ layer in Example 5. A multilayer film was produced by the same method as that in Example 5 except for the foregoing.

### Comparative Example 3

A film was formed by changing the base material temperature to −10° C. so that an amorphous CeO₂ layer was obtained instead of the cubic polycrystalline CeO₂ layer in Example 2. A multilayer film was produced by the same method as that in Example 2 except for the foregoing.

### Comparative Example 4

A film was formed by changing the base material temperature to −10° C. so that an amorphous CeO₂ layer was obtained instead of the cubic polycrystalline CeO₂ layer in Example 5. A multilayer film was produced by the same method as that in Example 5 except for the foregoing.

### Comparative Example 5

The CeO₂ layer and the MgF₂ layer in Example 1 were each formed so that the thickness thereof was smaller than that in Example 1. A multilayer film was produced by the same method as that in Example 1 except for the foregoing.

### Comparative Example 6

The CeO₂ layer and the MgF₂ layer in Example 3 were each formed so that the thickness thereof was larger than that in Example 3. A multilayer film was produced by the same method as that in Example 3 except for the foregoing.

### Comparative Example 7

The CeO₂ layer and the SiO₂ layer in Example 4 were each formed so that the thickness thereof was smaller than that in Example 4. A multilayer film was produced by the same method as that in Example 4 except for the foregoing.

### Comparative Example 8

The CeO₂ layer and the SiO₂ layer in Example 6 were each formed so that the thickness thereof was larger than that in Example 6. A multilayer film was produced by the same method as that in Example 6 except for the foregoing.

### (Measurement of Thickness)

The thickness of each layer of the multilayer films of Examples and Comparative Examples was measured by spectroscopic ellipsometry (ESM300, manufactured by J.A. Woollam Co.). When the number of layers and the thickness were complicated, and analysis was difficult, the analysis was performed through use of the refractive index of a monolayer film separately obtained in film formation of the same batch, and the like.

### (Measurement of Composition)

The composition of the layer formed of two components, such as SiO₂+CeO₂ or SiO₂+Al₂O₃, in the multilayer films of Examples and Comparative Examples was determined by measurement with a wavelength-dispersive fluorescence X-ray spectroscopic analyzer (ZSX Primus II, manufactured by Rigaku Corporation).

### (Measurement of Crystallinity)

Each of the multilayer films of Examples and Comparative Examples was measured in a range of 2θ=20° to 100° with an XRD diffraction apparatus (Smart Lab, manufactured by Rigaku Corporation), and layers were identified and crystallinity was determined based on a diffraction line intensity and the like.

### (Evaluation of Hydrophilicity Maintenance)

Each of the multilayer films of Examples and Comparative Examples was left in the dark for 180 days, and then, its contact angle with water was measured. A model CA-X150 manufactured by Kyowa Interface Science Co., Ltd. was used as a contact angle meter. 2.5 mL of pure water was dropped onto a test piece from a microsyringe, and the contact angle 5 seconds after the dropping was determined by a θ/2 method.

The hydrophilicity of a surface may be quantified by the contact angle with water. In general, a case in which the contact angle is less than 20° is referred to as “hydrophilic”, and a case in which the contact angle is less than 10° is referred to as “superhydrophilic”. Following this, a case in which the contact angle was less than 10° was evaluated as [A], a case in which the contact angle was 10° or more and less than 20° was evaluated as [B], and a case in which the contact angle was 20° or more was evaluated as [C].

### (Evaluation of Self-Cleaning Performance)

Stearic acid was applied to each of the multilayer films of Examples and Comparative Examples through use of a heptane solution of stearic acid (0.3 mass %) in conformity with JIS R1753-1 and dried in a dryer at 70° C. for 30 minutes. After that, the contact angle of the test piece having stearic acid applied thereto was measured by the same method as that described in the section (Evaluation of Hydrophilicity Maintenance), and it was recognized that the contact angle was 20° or more. After that, the test piece was irradiated with ultraviolet light for 6 hours, and then the contact angle was measured again to determine a water contact angle after the irradiation with ultraviolet light. A black light blue fluorescent lamp (FL20SBL-B, manufactured by Hotalux, Ltd.) was used as an ultraviolet light source. The test piece was irradiated with ultraviolet light at an illuminance of 2.0 mw/cm².

In the same manner as in the above-mentioned evaluation in the section (Evaluation of Hydrophilicity Maintenance), a case in which the contact angle was less than 10° was evaluated as [A], a case in which the contact angle was 10° or more and less than 20° was evaluated as [B], and a case in which the contact angle was 20° or more was evaluated as [C].

The results obtained in the sections (Evaluation of Hydrophilicity Maintenance) and (Evaluation of Self-cleaning Performance) are shown in Table 1. In each of Examples and Comparative Examples, the evaluation results were the same regardless of the kind of the base material.

TABLE 1

| | | Base | | | | | |
|---|---|---|---|---|---|---|---|
| | | material | | | | | |
| | | temperature | | | | | |
| | | at time of | | | | Layer 17 formed of | |
| | | vapor | Layer 13 containing cerium oxide | | | first metal oxide | |
| | | deposition | | | Thickness | | Thickness |
| | | [° C.] | Composition | Crystallinity | [nm] | Composition | [nm] |
| Example | 1 | 350 | CeO₂ | Polycrystalline | 72 | — | — |
| Example | 2 | 350 | CeO₂ | Polycrystalline | 123 | — | — |
| Example | 3 | 350 | CeO₂ | Polycrystalline | 296 | — | — |
| Example | 4 | 350 | CeO₂ | Polycrystalline | 72 | — | — |
| Example | 5 | 350 | CeO₂ | Polycrystalline | 123 | — | — |
| Example | 6 | 350 | CeO₂ | Polycrystalline | 291 | — | — |
| Example | 7 | 350 | CeO_{1.8} | Polycrystalline | 125 | — | — |
| Example | 8 | 350 | CeO_{1.8} | Polycrystalline | 125 | — | — |
| Example | 9 | 350 | CeO_{1.5} | Polycrystalline | 179 | — | — |
| | | | (85%) + La₂O₃ | | | | |
| | | | (15%) | | | | |
| Example | 10 | 350 | CeO_{1.8} | Polycrystalline | 190 | — | — |
| | | | (85%) + Al₂O₃ | | | | |
| | | | (15%) | | | | |
| Example | 11 | 350 | CeO_{1.5} | Polycrystalline | 177 | — | — |
| | | | (85%) + Sm₂O₃ | | | | |
| | | | (15%) | | | | |
| Example | 12 | 350 | CeO₂ | Polycrystalline | 71 | — | — |
| Example | 13 | 350 | CeO₂ | Polycrystalline | 124 | — | — |
| Example | 14 | 350 | CeO₂ | Polycrystalline | 298 | — | — |
| Example | 15 | 350 | CeO₂ | Polycrystalline | 70 | — | — |
| Example | 16 | 350 | CeO₂ | Polycrystalline | 121 | — | — |
| Example | 17 | 350 | CeO₂ | Polycrystalline | 297 | — | — |
| Example | 18 | 350 | CeO₂ | Polycrystalline | 74 | — | — |
| Example | 19 | 350 | CeO₂ | Polycrystalline | 125 | — | — |
| Example | 20 | 350 | CeO₂ | Polycrystalline | 298 | — | — |
| Example | 21 | 350 | CeO₂ | Polycrystalline | 72 | — | — |
| Example | 22 | 350 | CeO₂ | Polycrystalline | 128 | — | — |
| Example | 23 | 350 | CeO₂ | Polycrystalline | 300 | — | — |
| Example | 24 | 350 | CeO₂ | Polycrystalline | 71 | — | — |
| Example | 25 | 350 | CeO₂ | Polycrystalline | 130 | — | — |
| Example | 26 | 350 | CeO₂ | Polycrystalline | 299 | — | — |
| Example | 27 | 350 | CeO₂ | Polycrystalline | 72 | — | — |
| Example | 28 | 350 | CeO₂ | Polycrystalline | 122 | — | — |
| Example | 29 | 350 | CeO₂ | Polycrystalline | 298 | — | — |
| Example | 30 | 350 | CeO₂ | Polycrystalline | 72 | — | — |
| Example | 31 | 350 | CeO₂ | Polycrystalline | 121 | CuO | 0.5 |
| Example | 32 | 350 | CeO₂ | Polycrystalline | 127 | CuO | 5 |
| Example | 33 | 350 | CeO₂ | Polycrystalline | 123 | CuO | 15 |
| Example | 34 | 350 | CeO_{1.5} | Polycrystalline | 150 | CeO₂ | 0.6 |
| | | | (85%) + La₂O₃ | | | | |
| | | | (15%) | | | | |
| Example | 35 | 350 | CeO_{1.8} | Polycrystalline | 156 | CeO₂ | 5 |
| | | | (85%) + Al₂O₃ | | | | |
| | | | (15%) | | | | |
| Example | 36 | 350 | CeO_{1.5} | Polycrystalline | 151 | CeO₂ | 15 |
| | | | (85%) + Sm₂O₃ | | | | |
| | | | (15%) | | | | |
| Example | 37 | 350 | CeO₂ | Polycrystalline | 120 | — | — |
| Example | 38 | 350 | CeO₂ | Polycrystalline | 124 | — | — |
| Example | 39 | 350 | CeO₂ | Polycrystalline | 129 | — | — |
| Example | 40 | 350 | CeO₂ | Polycrystalline | 123 | — | — |
| Example | 41 | 350 | CeO₂ | Polycrystalline | 126 | — | — |
| Example | 42 | 350 | CeO₂ | Polycrystalline | 122 | — | — |
| Example | 43 | 28 | CeO₂ | Polycrystalline | 131 | — | — |
| Example | 44 | 28 | CeO₂ | Polycrystalline | 133 | — | — |
| Example | 45 | 29 | CeO₂ | Polycrystalline | 300 | — | — |
| Example | 46 | 33 | CeO₂ | Polycrystalline | 129 | — | — |
| Example | 47 | 350 | CeO₂ | Polycrystalline | 115 | CuO | 10 |
| Example | 48 | 350 | CeO₂ | Polycrystalline | 120 | CuO | 7 |
| Comparative | 1 | 350 | TiO₂ | Polycrystalline | 114 | — | — |
| Example | | | | | | | |
| Comparative | 2 | 350 | TiO₂ | Polycrystalline | 111 | — | — |
| Example | | | | | | | |
| Comparative | 3 | −10 | CeO₂ | Amorphous | 139 | — | — |
| Example | | | | | | | |
| Comparative | 4 | −10 | CeO₂ | Amorphous | 141 | — | — |
| Example | | | | | | | |
| Comparative | 5 | 350 | CeO₂ | Polycrystalline | 65 | — | — |
| Example | | | | | | | |
| Comparative | 6 | 350 | CeO₂ | Polycrystalline | 333 | — | — |
| Example | | | | | | | |
| Comparative | 7 | 350 | CeO₂ | Polycrystalline | 65 | — | — |
| Example | | | | | | | |
| Comparative | 8 | 350 | CeO₂ | Polycrystalline | 323 | — | — |
| Example | | | | | | | |

| | | Layer 14 containing magnesium fluoride or | | | Layer 18 formed of | |
|---|---|---|---|---|---|---|
| | | layer 15 containing silicon oxide | | | second metal oxide | |
| | | | Refractive | Thickness | | Thickness |
| | | Composition | index [—] | [nm] | Composition | [nm] |
| Example | 1 | MgF₂ | 1.38 | 50 | — | — |
| Example | 2 | MgF₂ | 1.38 | 97 | — | — |
| Example | 3 | MgF₂ | 1.38 | 240 | — | — |
| Example | 4 | SiO₂ | 1.47 | 51 | — | — |
| Example | 5 | SiO₂ | 1.47 | 96 | — | — |
| Example | 6 | SiO₂ | 1.47 | 236 | — | — |
| Example | 7 | MgF₂ | 1.38 | 98 | — | — |
| Example | 8 | SiO₂ | 1.47 | 93 | — | — |
| Example | 9 | MgF₂ | 1.38 | 133 | — | — |
| Example | 10 | SiO₂ | 1.47 | 130 | — | — |
| Example | 11 | SiO₂ | 1.47 | 131 | — | — |
| Example | 12 | SiO₂ (99.9%) + Al₂O₃ (0.1%) | 1.47 | 52 | — | — |
| Example | 13 | SiO₂ (99.9%) + Al₂O₃ (0.1%) | 1.47 | 92 | — | — |
| Example | 14 | SiO₂ (99.9%) + Al₂O₃ (0.1%) | 1.47 | 240 | — | — |
| Example | 15 | SiO₂ (90%) + Al₂O₃ (10%) | 1.53 | 52 | — | — |
| Example | 16 | SiO₂ (90%) + Al₂O₃ (10%) | 1.53 | 89 | — | — |
| Example | 17 | SiO₂ (90%) + Al₂O₃ (10%) | 1.53 | 237 | — | — |
| Example | 18 | SiO₂ (99.9%) + CeO₂ (0.1%) | 1.48 | 53 | — | — |
| Example | 19 | SiO₂ (99.9%) + CeO₂ (0.1%) | 1.48 | 92 | — | — |
| Example | 20 | SiO₂ (99.9%) + CeO₂ (0.1%) | 1.48 | 237 | — | — |
| Example | 21 | SiO₂ (65%) + CeO₂ (35%) | 0.64 | 51 | — | — |
| Example | 22 | SiO₂ (65%) + CeO₂ (35%) | 1.65 | 87 | — | — |
| Example | 23 | SiO₂ (65%) + CeO₂ (35%) | 1.65 | 236 | — | — |
| Example | 24 | MgF₂ | 1.38 | 50 | — | — |
| Example | 25 | MgF₂ | 1.38 | 97 | — | — |
| Example | 26 | SiO₂ (97.5%) + Al₂O₃ (2.5%) | 1.48 | 238 | — | — |
| Example | 27 | SiO₂ (95%) + Al₂O₃ (5%) | 1.49 | 50 | — | — |
| Example | 28 | SiO₂ (95%) + CeO₂ (5%) | 1.48 | 90 | — | — |
| Example | 29 | SiO₂ (95%) + CeO₂ (5%) | 1.65 | 240 | — | — |
| Example | 30 | SiO₂ (95%) + CeO₂ (5%) | 1.51 | 51 | — | — |
| Example | 31 | SiO₂ (95%) + CeO₂ (5%) | 1.51 | 90 | — | — |
| Example | 32 | SiO₂ (95%) + CeO₂ (5%) | 1.51 | 91 | — | — |
| Example | 33 | SiO₂ (95%) + CeO₂ (5%) | 1.51 | 92 | — | — |
| Example | 34 | SiO₂ (95%) + CeO₂ (5%) | 1.51 | 109 | — | — |
| Example | 35 | SiO₂ (95%) + CeO₂ (5%) | 1.51 | 121 | — | — |
| Example | 36 | SiO₂ (95%) + CeO₂ (5%) | 1.51 | 111 | — | — |
| Example | 37 | SiO₂ (95%) + CeO₂ (5%) | 1.51 | 91 | CuO | 0.5 |
| Example | 38 | SiO₂ (95%) + CeO₂ (5%) | 1.51 | 89 | CuO | 4 |
| Example | 39 | SiO₂ (95%) + CeO₂ (5%) | 1.51 | 88 | CuO | 7 |
| Example | 40 | SiO₂ (95%) + CeO₂ (5%) | 1.51 | 91 | CeO₂ | 0.6 |
| Example | 41 | SiO₂ (95%) + CeO₂ (5%) | 1.51 | 91 | CeO₂ | 4 |
| Example | 42 | SiO₂ (95%) + CeO₂ (5%) | 1.51 | 90 | CeO₂ | 7 |
| Example | 43 | SiO₂ | 1.47 | 93 | — | — |
| Example | 44 | SiO₂ (90%) + Al₂O₃ (10%) | 1.53 | 88 | — | — |
| Example | 45 | SiO₂ (95%) + CeO₂ (5%) | 1.65 | 239 | — | — |
| Example | 46 | SiO₂ (95%) + CeO₂ (5%) | 1.51 | 82 | CeO₂ | 5 |
| Example | 47 | SiO₂ (95%) + CeO₂ (5%) | 1.51 | 75 | CeO₂ | 3 |
| Example | 48 | MgF₂ (85%) + CaF₂ (15%) | 1.36 | 93 | — | — |
| Comparative | 1 | MgF₂ | 1.38 | 98 | — | — |
| Example | | | | | | |
| Comparative | 2 | SiO₂ | 1.47 | 93 | — | — |
| Example | | | | | | |
| Comparative | 3 | MgF₂ | 1.36 | 99 | — | — |
| Example | | | | | | |
| Comparative | 4 | SiO₂ | 1.44 | 95 | — | — |
| Example | | | | | | |
| Comparative | 5 | MgF₂ | 1.38 | 47 | — | — |
| Example | | | | | | |
| Comparative | 6 | MgF₂ | 1.38 | 256 | — | — |
| Example | | | | | | |
| Comparative | 7 | SiO₂ | 1.47 | 46 | — | — |
| Example | | | | | | |
| Comparative | 8 | SiO₂ | 1.47 | 261 | — | — |
| Example | | | | | | |

| | |
|---|---|
| Evaluation of | Evaluation of self- |
| hydrophilicity | cleaning performance |

| | | | | | maintenance | | Contact | |
|---|---|---|---|---|---|---|---|---|
| | | Layer 16 containing silicon | | | Contact | | angle after | |
| | | dioxide | | | angle after | | UV | |
| | | | Refractive | Thickness | being left | | irradiation | |
| | | Composition | index [—] | [nm] | in dark [°] | Evaluation | [°] | Evaluation |
| Example | 1 | — | — | — | 11 | B | 8 | A |
| Example | 2 | — | — | — | 7 | A | 7 | A |
| Example | 3 | — | — | — | 6 | A | 7 | A |
| Example | 4 | — | — | — | 11 | B | 8 | A |
| Example | 5 | — | — | — | 6 | A | 7 | A |
| Example | 6 | — | — | — | 5 | A | 8 | A |
| Example | 7 | — | — | — | 7 | A | 5 | A |
| Example | 8 | — | — | — | 6 | A | 6 | A |
| Example | 9 | — | — | — | 7 | A | 6 | A |
| Example | 10 | — | — | — | 6 | A | 7 | A |
| Example | 11 | — | — | — | 5 | A | 7 | A |
| Example | 12 | — | — | — | 13 | B | 7 | A |
| Example | 13 | — | — | — | 6 | A | 7 | A |
| Example | 14 | — | — | — | 5 | A | 7 | A |
| Example | 15 | — | — | — | 12 | B | 7 | A |
| Example | 16 | — | — | — | 7 | A | 7 | A |
| Example | 17 | — | — | — | 6 | A | 7 | A |
| Example | 18 | — | — | — | 12 | B | 6 | A |
| Example | 19 | — | — | — | 6 | A | 6 | A |
| Example | 20 | — | — | — | 6 | A | 6 | A |
| Example | 21 | — | — | — | 16 | B | 7 | A |
| Example | 22 | — | — | — | 5 | A | 5 | A |
| Example | 23 | — | — | — | 5 | A | 5 | A |
| Example | 24 | SiO₂ | 1.45 | 1 | 15 | B | 7 | A |
| Example | 25 | SiO₂ | 1.47 | 29 | 5 | A | 7 | A |
| Example | 26 | SiO₂ | 1.47 | 29 | 5 | A | 5 | A |
| Example | 27 | SiO₂ | 1.45 | 2 | 14 | B | 5 | A |
| Example | 28 | SiO₂ | 1.45 | 1 | 5 | A | 5 | A |
| Example | 29 | SiO₂ | 1.47 | 30 | 5 | A | 5 | A |
| Example | 30 | SiO₂ | 1.47 | 30 | 10 | B | 5 | A |
| Example | 31 | — | — | — | 7 | A | 5 | A |
| Example | 32 | — | — | — | 8 | A | 4 | A |
| Example | 33 | — | — | — | 9 | A | 3 | A |
| Example | 34 | — | — | — | 5 | A | 5 | A |
| Example | 35 | — | — | — | 6 | A | 5 | A |
| Example | 36 | — | — | — | 6 | A | 5 | A |
| Example | 37 | SiO₂ | 1.46 | 15 | 7 | A | 4 | A |
| Example | 38 | SiO₂ | 1.46 | 15 | 9 | A | 4 | A |
| Example | 39 | SiO₂ | 1.46 | 15 | 9 | A | 3 | A |
| Example | 40 | SiO₂ | 1.46 | 15 | 5 | A | 5 | A |
| Example | 41 | SiO₂ | 1.46 | 15 | 6 | A | 4 | A |
| Example | 42 | SiO₂ | 1.46 | 15 | 6 | A | 3 | A |
| Example | 43 | — | — | — | 5 | A | 3 | A |
| Example | 44 | — | — | — | 5 | A | 4 | A |
| Example | 45 | SiO₂ | 1.47 | 30 | 5 | A | 4 | A |
| Example | 46 | SiO₂ | 1.46 | 15 | 5 | A | 5 | A |
| Example | 47 | SiO₂ | 1.46 | 15 | 9 | A | 2 | A |
| Example | 48 | — | — | — | 9 | A | 5 | A |
| Comparative | 1 | — | — | — | 49 | C | 55 | C |
| Example | | | | | | | | |
| Comparative | 2 | — | — | — | 33 | C | 41 | C |
| Example | | | | | | | | |
| Comparative | 3 | — | — | — | 14 | B | 61 | C |
| Example | | | | | | | | |
| Comparative | 4 | — | — | — | 12 | B | 41 | C |
| Example | | | | | | | | |
| Comparative | 5 | — | — | — | 33 | C | 50 | C |
| Example | | | | | | | | |
| Comparative | 6 | — | — | — | 5 | A | 51 | C |
| Example | | | | | | | | |
| Comparative | 7 | — | — | — | 32 | C | 52 | C |
| Example | | | | | | | | |
| Comparative | 8 | — | — | — | 4 | A | 53 | C |
| Example | | | | | | | | |

### Example 49

A flat glass sheet including the multilayer film obtained in Example 3 was processed and mounted to the outside of a near-infrared sensor of a commercially available vehicle so as to serve as a protective cover for the sensor.

### Example 50

A dome-shaped transparent substrate made of a polymethyl methacrylate resin was used as a base material to be used, and a SiO₂ film (200 nm) was formed as a first layer through use of SiO as a film forming material. A ZrO₂ film (15 nm) was formed as a second layer through use of ZrO₂. A SiO₂ film (35 nm) was formed as a third layer through use of SiO₂. A CeO₂ film (117 nm) was formed as a fourth layer through use of CeO₂. A CuO film (7 nm) was formed as a fifth layer through use of CuO. A SiO₂ (95%)+CeO₂ (5%) film (80 nm) was formed as a sixth layer through use of SiO₂ and CeO₂. A SiO₂ film (13 nm) was formed as a final seventh layer through use of SiO₂. Thus, a multilayer film was produced. During film formation, the multilayer film was produced at a vapor deposition rate of 0.5 nm/sec while the base material was subjected to planetary rotation under non-heating conditions. In addition, when the first, fourth, fifth, and sixth layers were formed, ion assisted deposition was performed through use of an RF ion source under the condition of an O₂ gas flow rate of 40 sccm. In this case, in the first layer, the ion assisted deposition was performed under the conditions of an accelerating voltage value of 250 V and an accelerating current value of 250 mA. In addition, in the fourth, fifth, and sixth layers, the ion assisted deposition was performed under the conditions of an accelerating voltage value of 500 V and an accelerating current value of 500 mA. The resultant dome-shaped resin substrate with a multilayer film was mounted to a surveillance camera for use as a surveillance camera cover.

The surveillance camera having the produced cover mounted thereto was stored in a product packaging box that was a dark place for 3 months. After that, the surveillance camera was installed outdoors when it rained at night. Even when water adhered to the surveillance camera due to rain, the water droplets were wet-spread on the cover, and hence satisfactory visibility was maintained. In addition, even after the moisture was dried, no water marks remained, and hence satisfactory visibility was maintained. Further, even when it rained 6 months after the surveillance camera was installed outdoors, water droplets were wet-spread on the cover, and hence satisfactory visibility was maintained.

### Example 51

A resin substrate (MR-8, manufactured by Mitsui Chemicals, Inc.) having a silicon-based hard coat formed thereon was used as a base material to be used, and an Al₂O₃ film (82 nm) was formed as a first layer through use of Al₂O₃. A CeO₂ film (119 nm) was formed as a second layer through use of CeO₂. A CuO film (7 nm) was formed as a third layer through use of CuO. A SiO₂ (95%)+CeO₂ (5%) film (79 nm) was formed as a fourth layer through use of SiO₂ and CeO₂. A SiO₂ film (15 nm) was formed as a final fifth layer through use of SiO₂. Thus, a multilayer film was produced. During film formation, the multilayer film was produced at a vapor deposition rate of 0.5 nm/sec by heating the base material to a temperature of 80° C. The resultant resin substrate with the multilayer film was processed and mounted to a frame for a pair of eyeglasses, to thereby produce a pair of eyeglasses. The pair of eyeglasses thus produced was stored in an eyeglass case that was a dark place for 3 months. After that, when water airborne droplets were allowed to adhere to a lens, the water droplets were wet-spread on the lens, and hence satisfactory visibility was maintained. The contact angle of water in this case was 5°. In addition, even after the moisture was dried, no water marks remained, and hence satisfactory visibility was maintained.

The multilayer film of the present disclosure may be used in, for example, optical members, such as an optical filter, an optical lens, a daylighting lens, an optical film, an optical prism, an eyeglass lens, a photographic lens, a vehicle door mirror, a glass sheet, a condenser lens, a display cover glass, a touch panel, and various kinds of films, or covers for protecting optical members, such as a surveillance camera cover, an in-vehicle camera cover, and an in-vehicle sensor cover.

In addition, the optical member of the present disclosure may be used in, for example, optical devices, such as a digital camera, a digital video camera, an action camera, an endoscope, a lens barrel, a pair of eyeglasses, a sensor, a pair of binoculars, a telescope, a surveillance camera, an in-vehicle camera, a smartphone, a tablet PC, a weather camera, a live camera, a pair of protective goggles, a pair of swimming goggles, a head-mounted display, a pair of sunglasses, a pair of smart glasses, a face shield, a helmet shield, a vehicle mirror, and a bathroom mirror, or covers for protecting the optical devices.

The present disclosure includes the following embodiments.
(1)
   A multilayer film including:
   a layer containing cerium oxide; and
   a layer containing silicon oxide or a layer containing magnesium fluoride formed on the layer containing cerium oxide directly or through intermediation of another layer,
   wherein the layer containing cerium oxide contains cerium oxide having a cubic polycrystalline structure,
   wherein the layer containing cerium oxide has a thickness of 70 nm or more and 300 nm or less,
   wherein the layer containing silicon oxide and the layer containing magnesium fluoride each have a thickness of 50 nm or more and 240 nm or less, and
   wherein the layer containing silicon oxide and the layer containing magnesium fluoride each have a refractive index of 1.65 or less at a wavelength of 500 nm.
(2)
   The multilayer film according to (1), wherein the cerium oxide in the layer containing cerium oxide has a composition CeOₓ where x=1.5 or more and 2.0 or less.
(3)
   The multilayer film according to (1) or (2), wherein a content ratio of the cerium oxide in the layer containing cerium oxide is 85 mass % or more with respect to an entirety of the layer containing cerium oxide.
(4)
   The multilayer film according to any one of (1) to (3), wherein a content ratio of the silicon oxide in the layer containing silicon oxide is 65 mass % or more with respect to an entirety of the layer containing silicon oxide.
(5)
   The multilayer film according to (4),
   wherein the layer containing silicon oxide contains aluminum oxide, and
   wherein a content ratio of the aluminum oxide in the layer containing silicon oxide is 0.1 mass % or more and 10 mass % or less with respect to the entirety of the layer containing silicon oxide.
(6)
   The multilayer film according to (4),
   wherein the layer containing silicon oxide contains cerium oxide, and
   wherein a content ratio of the cerium oxide in the layer containing silicon oxide is 0.1 mass % or more and 35 mass % or less.
(7)
   The multilayer film according to any one of (1) to (6) further including a layer containing silicon dioxide formed on the layer containing silicon oxide or the layer containing magnesium fluoride directly or through intermediation of another layer,
   wherein the layer containing silicon dioxide has a thickness of 30 nm or less.
(8)
   The multilayer film according to any one of (1) to (7) further including a layer formed of a first metal oxide between the layer containing cerium oxide and the layer containing silicon oxide or the layer containing magnesium fluoride,
   wherein the layer formed of a first metal oxide contains a metal oxide having a polycrystalline structure, and
   wherein the layer formed of a first metal oxide has a thickness of 0.5 nm or more and 15 nm or less.
(9)
   The multilayer film according to (8), wherein the metal oxide is copper oxide represented by a composition CuOₓ where x=0.5 or more and 1.0 or less.
(10)
   The multilayer film according to (8), wherein the metal oxide is cerium oxide having a cubic polycrystalline structure represented by a composition CeOₓ where x=1.5 or more and 2.0 or less.
(11)
   The multilayer film according to (7) further including a layer formed of a second metal oxide between the layer containing silicon oxide or the layer containing magnesium fluoride and the layer containing silicon dioxide,
   wherein the layer formed of a second metal oxide contains a metal oxide having a polycrystalline structure, and
   wherein the layer formed of a second metal oxide has a thickness of 0.5 nm or more and 7 nm or less.
(12)
   The multilayer film according to (11), wherein the metal oxide is copper oxide represented by a composition CuOₓ where x=0.5 or more and 1.0 or less.
(13)
   The multilayer film according to (11), wherein the metal oxide is cerium oxide having a cubic polycrystalline structure represented by a composition CeOₓ where x=1.5 or more and 2.0 or less.
(14)
   An optical member including the multilayer film of any one of (1) to (13).
(15)
   A method of producing a multilayer film, the method including:
   forming a layer containing cerium oxide on a base material directly or through intermediation of another layer by a vacuum vapor deposition method; and
   forming a layer containing silicon oxide or a layer containing magnesium fluoride on the layer containing cerium oxide directly or through intermediation of another layer by the vacuum vapor deposition method,
   wherein the layer containing cerium oxide contains cerium oxide having a cubic polycrystalline structure,
   wherein the layer containing cerium oxide has a thickness of 70 nm or more and 300 nm or less,
   wherein the layer containing silicon oxide and the layer containing magnesium fluoride each have a thickness of 50 nm or more and 240 nm or less, and
   wherein the layer containing silicon oxide and the layer containing magnesium fluoride each have a refractive index of 1.65 or less at a wavelength of 500 nm.

What is claimed is:

1. A multilayer film comprising:
a layer containing cerium oxide; and
a layer containing silicon oxide or a layer containing magnesium fluoride formed on the layer containing cerium oxide directly or through intermediation of another layer,
wherein the layer containing cerium oxide contains cerium oxide having a cubic polycrystalline structure,
wherein the layer containing cerium oxide has a thickness of 70 nm or more and 300 nm or less,
wherein the layer containing silicon oxide and the layer containing magnesium fluoride each have a thickness of 50 nm or more and 240 nm or less, and
wherein the layer containing silicon oxide and the layer containing magnesium fluoride each have a refractive index of 1.65 or less at a wavelength of 500 nm.

2. The multilayer film according to claim 1, wherein the cerium oxide in the layer containing cerium oxide has a composition CeOₓ where x=1.5 or more and 2.0 or less.

3. The multilayer film according to claim 1, wherein a content ratio of the cerium oxide in the layer containing cerium oxide is 85 mass % or more with respect to an entirety of the layer containing cerium

4. The multilayer film according to claim 1, wherein a content ratio of the silicon oxide in the layer containing silicon oxide is 65 mass % or more with respect to an entirety of the layer containing silicon oxide.

5. The multilayer film according to claim 4,
wherein the layer containing silicon oxide contains aluminum oxide, and
wherein a content ratio of the aluminum oxide in the layer containing silicon oxide is 0.1 mass % or more and 10 mass % or less with respect to the entirety of the layer containing silicon oxide.

6. The multilayer film according to claim 4,
wherein the layer containing silicon oxide contains cerium oxide, and
wherein a content ratio of the cerium oxide in the layer containing silicon oxide is 0.1 mass % or more and 35 mass % or less.

7. The multilayer film according to claim 1 further comprising a layer containing silicon dioxide formed on the layer containing silicon oxide or the layer containing magnesium fluoride directly or through intermediation of another layer,
wherein the layer containing silicon dioxide has a thickness of 30 nm or less.

8. The multilayer film according to claim 1 further comprising a layer formed of a first metal oxide between the layer containing cerium oxide and the layer containing silicon oxide or the layer containing magnesium fluoride,
wherein the layer formed of a first metal oxide contains a metal oxide having a polycrystalline structure, and
wherein the layer formed of a first metal oxide has a thickness of 0.5 nm or more and 15 nm or less.

9. The multilayer film according to claim 8, wherein the metal oxide is copper oxide represented by a composition CuOₓ where x=0.5 or more and 1.0 or less.

10. The multilayer film according to claim 8, wherein the metal oxide is cerium oxide having a cubic polycrystalline structure represented by a composition CeOₓ where x=1.5 or more and 2.0 or less.

11. The multilayer film according to claim 7 further comprising a layer formed of a second metal oxide between the layer containing silicon oxide or the layer containing magnesium fluoride and the layer containing silicon dioxide,
wherein the layer formed of a second metal oxide contains a metal oxide having a polycrystalline structure, and
wherein the layer formed of a second metal oxide has a thickness of 0.5 nm or more and 7 nm or less.

12. The multilayer film according to claim 11, wherein the metal oxide is copper oxide represented by a composition CuOₓ where x=0.5 or more and 1.0 or less.

13. The multilayer film according to claim 11, wherein the metal oxide is cerium oxide having a cubic polycrystalline structure represented by a composition CeOₓ where x=1.5 or more and 2.0 or less.

14. An optical member comprising the multilayer film of claim 1.

15. A method of producing a multilayer film, the method comprising:
forming a layer containing cerium oxide on a base material directly or through intermediation of another layer by a vacuum vapor deposition method; and
forming a layer containing silicon oxide or a layer containing magnesium fluoride on the layer containing cerium oxide directly or through intermediation of another layer by the vacuum vapor deposition method,
wherein the layer containing cerium oxide contains cerium oxide having a cubic polycrystalline structure,
wherein the layer containing cerium oxide has a thickness of 70 nm or more and 300 nm or less,
wherein the layer containing silicon oxide and the layer containing magnesium fluoride each have a thickness of 50 nm or more and 240 nm or less, and
wherein the layer containing silicon oxide and the layer containing magnesium fluoride each have a refractive index of 1.65 or less at a wavelength of 500 nm.
